(19) United States
(12) Patent Application Publication
(10) Pub. No.: US 2006/0064705 A1
(43) Pub. Date: Mar. 23, 2006

(54) Door-safety apparatus and disc player having the same

(75) Inventor: Sang-jin Bae, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/207,904

(22) Filed: Aug. 22, 2005

(30) Foreign Application Priority Data
Aug. 31, 2004 (KR) 2004-69061

(51) Int. Cl. G11B 17/04

(52) U.S. Cl. 720/607

(57) ABSTRACT

Provided is a door-safety apparatus and a disc player including the door-safety apparatus. The door-safety apparatus includes a front panel including an opening, a door that is pivotally installed at the front panel to pivot between an opened position in which the opening is to be opened and a closed position in which the opening is to be closed, a rising and falling guide ascending and descending a pickup base on which a turntable placing a disc thereon is installed, and a door-forcibly-opening preventing unit installed between the door and the rising and falling guide and selectively limiting pivoting of the door according to a position of the rising and falling guide. In a door-safety apparatus and a disc player including the door-safety apparatus, when a disc tray is in a disc loading position, a door can be prevented from being forcibly opened. Thus, when a child or a user opens the door during the operation of the disc player by accident, a safety-related accident occurring due to a disc rotating at a high speed can be prevented.

### CROSS-REFERENCE TO RELATED APPLICATIONS

This application claims the benefit of Korean Patent Application No. 2004-69061 filed on Aug. 31, 2004, in the Korean Intellectual Property Office, the disclosure of which is incorporated herein by reference.

### BACKGROUND OF THE INVENTION

1. Field of the Invention

The present invention relates to a disc player, such as a CD-ROM driver, a video disc device, a digital audio disc device, a DVD player, or the like, recording information on and/or reproducing information from a disc, and more particularly, to a door-safety apparatus to prevent a door through which a disc tray passes from being forcibly opened, and a disc player having the same.

2. Description of the Related Art

In general, disc players record information on, and/or reproduce information from, a disc-shaped recording medium. Such a disc player includes a door that opens and closes an opening formed at a front panel so that a disc tray goes into and out of a body. The door is classified into a single body type door forming a single body with a disc tray and a separate body type door separating from the disc tray.

FIGS. 1 and 2 illustrate a conventional disc player including a separate body type door.

A disc player 10 includes a body 11, a disc tray 12, a front panel 13, a door 14, and a torsion spring 15. The disc tray 12 is combined with the body 11 to slide into and out of the body 11 in first movement directions indicated by reference characters B and C shown in FIG. 1 so as to mount a disc thereon. The front panel 13 is assembled with a front portion of the body 11. The front panel 13 includes an opening 31 through which the disc tray 12 passes, supporters 32 and 32′ with which the door 14 is combined, and a back surface 34 to which a first arm 51 of the torsion spring 15 is fixed.

When the disc tray 12 is inserted into the body 11 in a disc loading position in which the disc is to be loaded, the door 14 covers the opening 31 so that the interior of the body 11 is not exposed. Left and right hinge arms 41 and 41′ are formed at both ends of the door 14 to be rotatably combined with the supporters 32 and 32′.

A regulator 42 is formed at the right hinge arm 41′ and contacts the back surface 34 of the front panel 13 so that the door 14 cannot rotate when the disc tray 12 is inserted into the body 11, and thus, closing the door 14. The torsion spring 15 is inserted into the right hinge arm 41′. The first arm 51 is combined with the back surface 34 of the front panel 13, and a second arm 52 is combined with the regulator 42 so that the torsion spring 15 applies an elastic force to the door 14 so as to rotate the door 14 in the direction D along which the door 14 is to be closed.

In the above-described structure, when the disc tray 12 is inserted into the body 11 to be in the disc loading position, the door 14 is closed by the elastic force of the torsion spring 15 and the contact between the regulator 42 and the back surface 34 of the front panel 13. Thereafter, when the disc tray 12 slides in the first movement direction B to mount the disc, a front surface 21 of the disc tray 12 contacts the door 14 to push the door 14 so as to rotate the door 14 in the direction E along which the door 14 is to be opened as illustrated in FIG. 2. Next, the disc tray 12 comes out of the body 11 through the opening 31 to be in an unloading position in which the disc is to be unloaded. When the disc tray 12 slides in the first movement direction C when the disk tray is inserted into the body 11, the door 14 rotates in the direction D due to the elastic force of the torsion spring 15 causing the door to be closed again.

However, in the disc player 10, the door 14 is closed only by the elastic force of the torsion spring 15. Thus, when the disc tray 12 is inserted into the body 11, and then the disc player 10 operates, a child or a user may forcibly open the door 14 by accident. In this case, a safety-related accident may occur because the disc that is rotating at a high speed.

Recently, disc players tend to rotate a disc at a high speed in order to facilitate large information storage capacity and high speed transmission of information. In other words, the revolution speed of discs reaches 52× speed from 1× speed through 16× speed and 32× speed. In a case where the rotation speed of a disc is 16× speed, the disc rotates at about 3600 revolution per minute (RPM). In a case where the revolution speed of the disc is 52× speed, the disc rotates at about 12,000 RPM.

In these cases, when a child or a user touches a disc that is rotating at a high speed with his or her hand, the child or the user may get injured by the disc. Also, when the child or the user touches the disc with a stick or the like, or the disc cracks even slightly, the disc may burst due to a revolution force of the disc that is rotating at the high speed and pieces of the burst disc may scatter at a very high speed. The pieces of the burst disc may come out of the body 11, and thus, may cause fatall injury.

### SUMMARY OF THE INVENTION

Accordingly, it is an aspect of the present invention to solve the above-mentioned and/or problems by providing a door-safety apparatus that prevents a door from being forcibly opened when a disc tray is in a disc loading position and a disc player having such door-safety apparatus.

According to an aspect of the present invention, there is provided a door-safety apparatus of a disc player including a front panel including an opening, a door pivotably installed at the front panel to pivot between an opened position in which the opening is to be opened and a closed position in which the opening is to be closed, a rising and falling guide that ascending and descending a pickup base on which a turntable placing a disc thereon is installed, and a door-forcibly-opening preventing unit installed between the door and the rising and falling guide and selectively limiting the pivoting of the door according to a position of the rising and falling guide.

The door-forcibly-opening preventing unit may include a first protrusion installed on an inner surface of the door, a second protrusion installed at the rising and falling guide that depends on the position of the rising and falling guide moving between an intercept position, in which the first protrusion is intercepted from moving with the door, and a release position in which the first protrusion is allowed to move. The second protrusion may be in the intercept position so as to limit the pivoting of the door when the rising and falling guide rises the pickup base to be in a disc placing position so as to place a disc on the turntable, and may be in the release position so as to allow the pivoting of the door when the rising and falling guide gets out of the disc placing position.

The first protrusion may include a protrusion piece protruding on the inner surface of the door inside the front panel and including at least one plane, and the second protrusion may include a protrusion bar extending toward the door and including a plane facing the plane of the protrusion piece when the second protrusion is in the intercept position.

The protrusion bar may include a movement guide guiding a movement of the protrusion bar between the intercept position and the release position. The movement guide may include a guide groove formed in the vicinity of the plane of the protrusion bar so as to be guided along a wall of a main base on which the pickup base is installed.

The door-forcibly-opening preventing unit may further include a stopper limiting a movement position of the rising and falling guide. The stopper may include a recess part formed at the wall of the main base on which the pickup base is installed so as to guide the second protrusion.

According to another aspect of the present invention, there is provided a disc player including a front panel assembly including a front panel including an opening, a door pivotably installed at the front panel to pivot between an opened position in which the opening is to be opened and a closed position in which the opening is to be closed, and an elastic member applying an elastic force to the door toward a direction along which the door pivots toward the closed position a body including a disc tray mounting a disc thereon and removed from or inserted into the front panel through the opening, and a rising and falling guide ascending and descending a pickup base on which a turntable placing the disc thereon is installed, and a door-safety apparatus including a door-forcibly-opening preventing unit installed between the door and the rising and falling guide and selectively limiting pivoting of the door according to a position of the rising and falling guide.

The door-forcibly-opening preventing unit may include a first protrusion installed on an inner surface of the door, and a second protrusion installed at the rising and falling guide, and according to the position of the rising and falling guide, moving between an intercept position in which the first protrusion is intercepted from moving with the door and a release position in which the first protrusion is allowed to move. The second protrusion may be in the intercept position so as to limit the pivoting of the door when the rising and falling guide raises the pickup base to be in a disc placing position so as to place a disc on the turntable, and it may be in the release position so as to allow the pivoting of the door when the rising and falling guide gets out of the disc placing position.

The first protrusion may include a protrusion piece protruding on the inner surface of the door inside the front panel and including at least one plane, and the second protrusion may include a protrusion bar extending toward the door and including a plane facing the plane of the protrusion piece when the second protrusion is in the intercept position.

The protrusion bar may include a movement guide guiding a movement of the protrusion bar between the intercept position and the release position. The movement guide may include a guide groove formed in the vicinity of the plane of the protrusion bar so as to be guided along a wall of a main base on which the pickup base is installed.

The door-forcibly-opening preventing unit may further include a stopper limiting a movement position of the rising and falling guide. The stopper may include a recess part formed at the wall of the main base on which the pickup base is installed so as to guide the second protrusion.

It is another aspect of the present invention to provide a door-safety method of a disc player including designing a front panel to include an opening, installing a door pivotably at the front panel, ascending and descending a pickup base on which a turntable placing a disc thereon is installed, and preventing the door from forcibly opening by selectively limiting pivoting of the door according to a position of a rising and falling guide.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a conventional disc player;

FIG. 2 is a cross-sectional view illustrating the conventional disc player, taken along line A-A′ shown in FIG. 1;

FIG. 3 is an exploded perspective view illustrating a disc player including a door-safety apparatus according to an embodiment of the present invention;

FIG. 4A is a partial perspective view of the disc player illustrated in FIG. 3 when a disc tray is in a disc loading position;

FIG. 4B is a partial perspective view of the disc player illustrated in FIG. 4A when the disc tray is removed;

FIG. 5A is a partial perspective view of the disc player illustrated in FIG. 3 when the disc tray is in a disc unloading position;

FIG. 5B is a partial perspective view of the disc player illustrated in FIG. 5A when the disc tray is removed;

FIGS. 6A and 6B are partial perspective views illustrating the operation of a door-safety apparatus of the disc player illustrated in FIG. 3; and

FIG. 7 is a front view of a rising and falling guide of the disc player illustrated in FIG. 3.

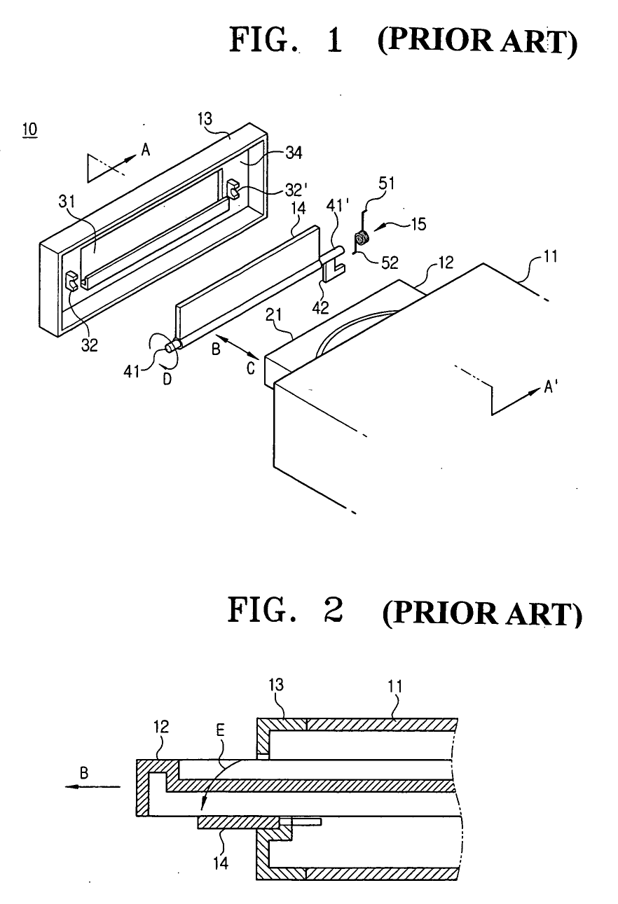

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A door-safety apparatus and a disc player including the door-safety apparatus according to the present invention will be described in detail with reference to the attached drawings.

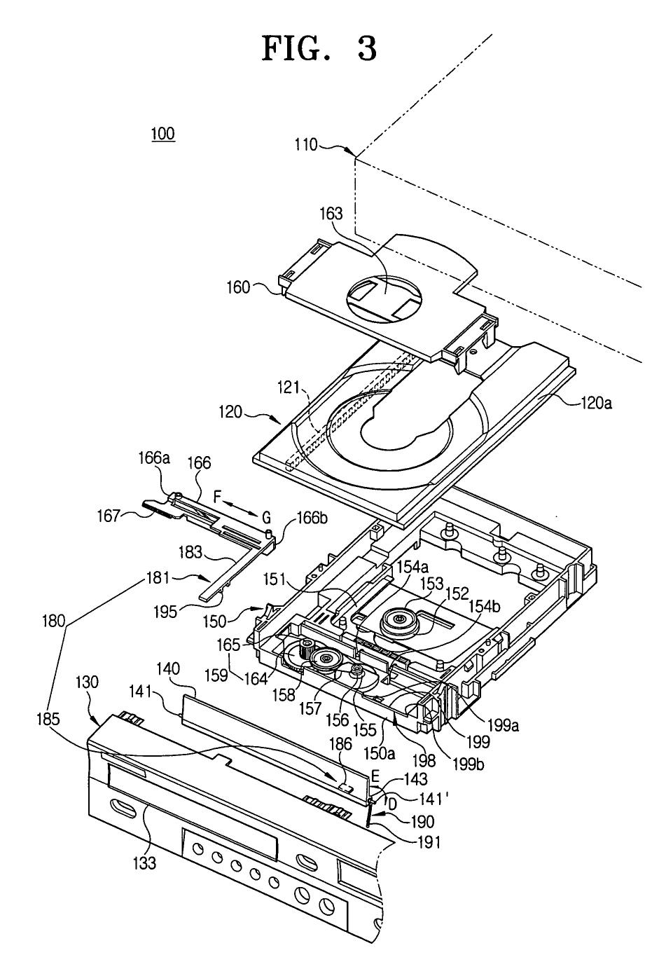

FIG. 3 is an exploded perspective view of a disc player 100 including a door-safety apparatus according to an embodiment of the present invention.

The disc player 100 includes a front panel 130, a main base 150, a pickup base 151, a disc tray 120, a disc clapping unit 160, a door-safety apparatus 180, and an outer case 110. The main base 150, the pickup base 151, the disc tray 120, the disc clapping unit 160, and the outer case 110 constitute a body of the disc player 100. The front panel 130 includes an opening 133 that is opened and closed by a door 140. The door 140 is supported by a support bracket (not shown) formed in the vicinity of the opening 133 so as to pivot left and right hinge arms 141 and 141′ formed at both lower ends of the door 140.

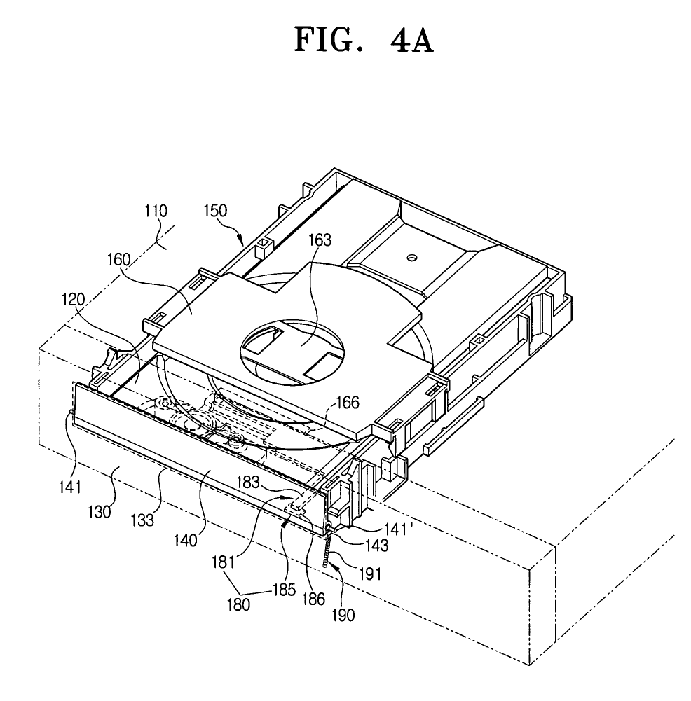

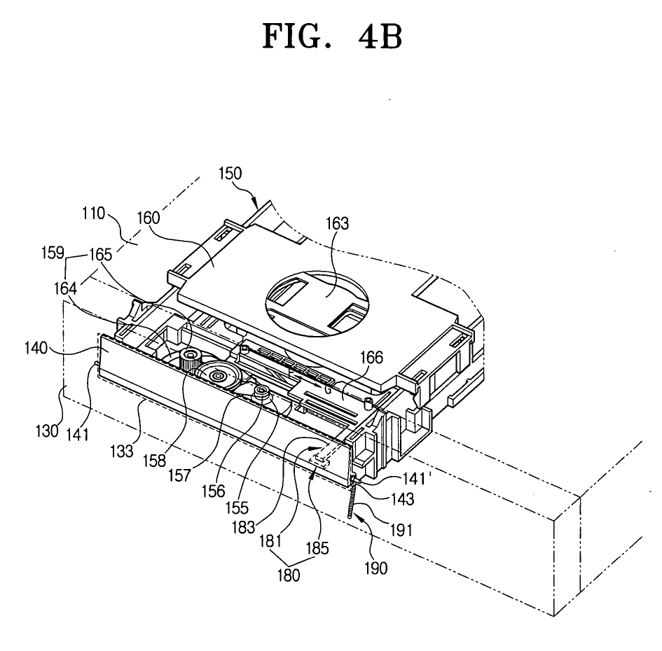

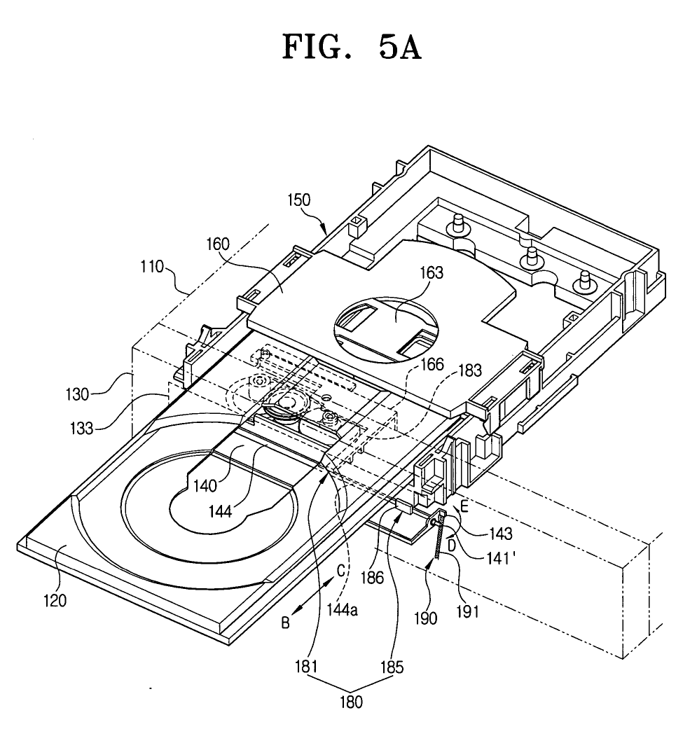

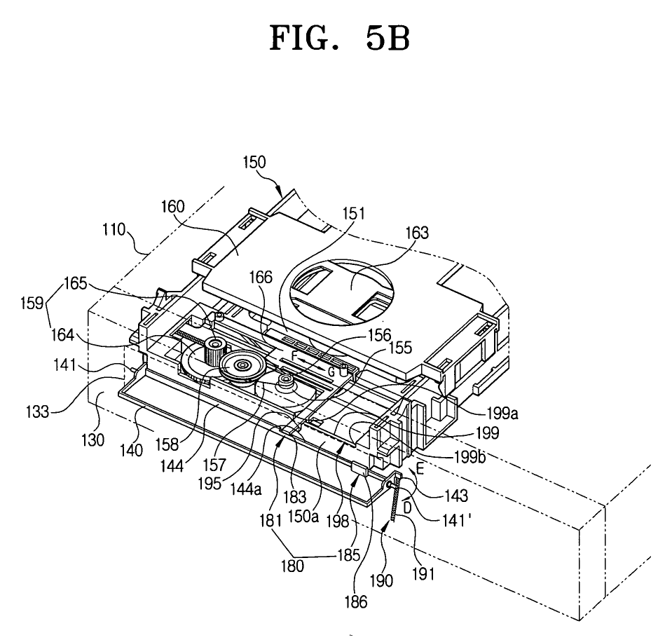

When the disc tray 120 moves, the door 140 pivots between an opened position (shown in FIGS. 5A and 5B) in which the opening 133 is opened by the disc tray 120 and a closed position (shown in FIGS. 4A and 4B) in which the opening 133 is closed.

A stationary bracket 143 is formed under the right hinge arm 141′ of the door 140. An elastic member 190 is fixed to the stationary bracket 143 and applies an elastic force to the door 140 in the direction D (shown in FIGS. 3, 5A, and 5B) along which the door 140 is to be closed.

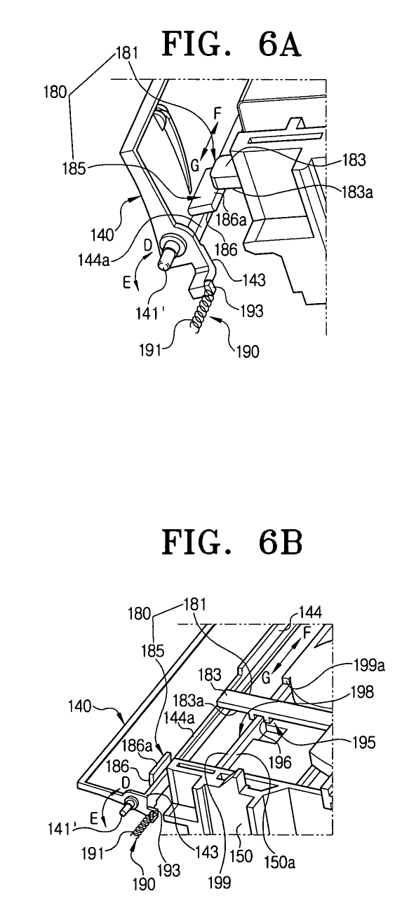

As shown in FIG. 6A, the elastic member 190 includes a tension spring 191 including an end fixed to a first hanger 193 formed on a lower end of the bracket 140 and the other end supported by a second hanger (not shown) formed on an inner surface of the front panel 130. The front panel 130 and the door 140 constitute a front panel assembly combined with the body. A loading motor 155 is installed on a front end of the main base 150 to provide a power for moving the disc tray 120, and power for ascending and descending the pickup base 151. The power of the loading motor 155 is transmitted from a motor pulley 156 installed on an output shaft to a gear pulley 158 via a belt 157. A first gear (not shown) formed under the gear pulley 158 gears with a second gear 164 of a loading gear 159 to transmit the power of the loading motor 155 to the loading gear 159.

The power of the loading motor 155 transmitted to the loading gear 159 is transmitted through a pinion gear 165 of the loading gear 159 to a first rack gear 123 formed on a lower surface of the disc tray 120. Thus, the disc tray 120 can move between a disc unloading position (shown in FIG. 5A) in which the disc tray 120 is to be removed from the front panel 130 through the opening 133 and a disc loading position (shown in FIG. 4A) in which the disc tray 120 is inserted into the front panel 130 through the opening 133.

The power of the loading motor 155 transmitted to the loading gear 159 is transmitted through the pinion gear 165 of the loading gear 159 to a second rack gear 167 formed at a first end 166a of a rising and falling guide 166. Thus, the rising and falling guide 166 is moved by the loading motor 155 in a second movement direction F or G (shown in FIGS, 3, 4B, 5B, and 7) orthogonal to first movement directions B and C (shown in FIG. 5A) along which the disc tray 120 moves.

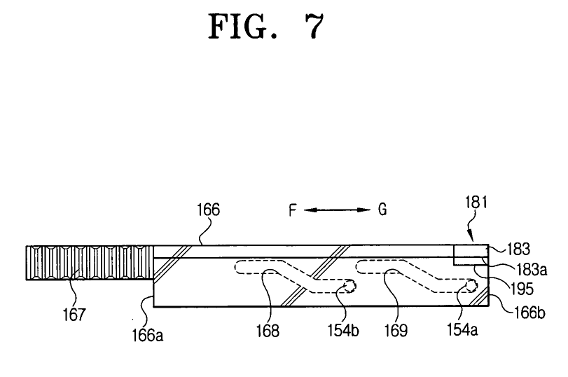

As shown in FIG. 7, the cam grooves 168 and 169 are formed at the rising and falling guide 166. Guide bosses 154a and 154b of the pickup base 151 that will be described later are inserted into and guided by the cam grooves 168 and 169.

The pickup base 151 is installed on the main base 150. The pickup base 151 operates so that a front end thereof ascends and descends at a predetermined angle by a support shaft (not shown) rotatably supported by both of the back sides of the main base 150. The guide bosses 154a and 154b guided by the cam grooves 168 and 169 of the rising and falling guide 166 are formed at the front end of the pickup base 151.

A spindle motor 152 is installed on the pickup base 151. A turntable 153 on which a disc is to be placed is installed at an output shaft of the spindle motor 152. A disc clapping unit 160 is fixed to the main base 150 above the turntable 153 and claps the disc placed on the turntable 153. A clap 163 is installed in the center of the disc clapping unit 160. The structure of the clap 163 is generally known and thus will not be described in detail herein.

The door-safety apparatus 180 selectively limits the pivoting of the door 140 according to the position of the rising and falling guide 160 moving in the second movement direction F or G with the movement of the disc tray 120. In other words, when the rising and falling guide 166 raises the pickup base 151 to be in a disc placing position (refer to FIGS. 4A, 4B, and 6A) in which the disc is to be placed on the turntable 153, the door-safety apparatus 180 limits the pivoting of the door 140. When the rising and falling guide 166 is in a position other than the disc placing position, the door-safety apparatus 180 allows the pivoting of the door 140.

For this purpose, the door-safety apparatus 180 includes a first protrusion 185 installed on an inner surface of the door 140 and a second protrusion 181 installed at a second end 166b of the rising and falling guide 166.

The first protrusion 185 includes a protrusion piece 186 protruding under the inner surface of the door 140 adjacent to the right hinge arm 141′ inside the front panel 130. As shown in FIG. 6A, the protrusion piece 186 includes an upper surface 186a formed in the form of a flat plane.

The second protrusion 181 includes a protrusion bar 183 extending from the second end 166b of the rising and falling guide 166 toward the door 140, i.e., in the first movement direction B along which the disc tray 120 moves. A front end of the protrusion bar 183 includes a lower surface 183a formed in the form of a flat plane and facing the upper surface 186a of the protrusion piece 186. As shown in FIGS. 4A, 4B, and 6A, when the door 140 is closed, the protrusion bar 183 partially overlaps with the protrusion piece 186 formed on the inner surface of the door 140, but the protrusion bar 183 does not contact the protrusion piece 186 so as not to obstruct the movement of the rising and falling guide 166.

The protrusion bar 183 moves between an intercept position (as shown in FIGS. 4A, 4B, and 6A) and a release position according to the position of the rising and falling guide 166, i.e., with the movement of the rising and falling guide 166. In the intercept position, the lower surface 183a of the front end of the protrusion bar 183 faces the upper surface 186a of the protrusion piece 186, and thus, the protrusion piece 186 is intercepted from pivoting with the door 140 to limit the pivoting of the door 140 when the door 140 pivots in direction E (shown in FIGS. 3, 5A, and 5B) along which the door 140 is to be opened. In the release position, as shown in FIGS. 5A, 5B, and 6B, the lower surface 183a of the front end of the protrusion bar 183 does not face the upper surface 186a of the protrusion piece 186. Therefore, when the door 150 pivots in the direction E, the protrusion piece 186 is allowed to pivot with the door 140 so that the door 140 freely pivots.

In other words, when the disc tray 120 is in the disc loading position as shown in FIG. 4A, i.e., the rising and falling guide 166 is in the disc placing position, the protrusion bar 183 is in the intercept position (as shown in FIGS. 4B and 6A). When the disc tray 120 is in a position other than the disc loading position, i.e., the rising and falling guide 166 is in a position other than the disc placing position, the protrusion bar 183 is in the release position.

The protrusion bar 183 further includes a movement guide 195 guiding the movement of the protrusion bar 183 between the intercept and release positions. As shown in FIG. 6B, the movement guide 195 includes a guide groove 196 protruding in a U-shape fashion in the vicinity of the lower surface 183a of the front end of the protrusion bar 183 so as to be guided along a recess part 199 of a stopper 198 that is formed on a front wall 150a of the main base 150 and will be described later.

In FIG. 6B, an incised part 144a is formed at a reinforcement rib 144 formed at a lower edge of the inner surface of the door 140 and incised by a distance to which the protrusion bar 183 moves within the release position. Thus, when the protrusion bar 183 is in the release position and the door 140 is opened, the incised part 144a intercepts the protrusion bar 183 from contacting the reinforcement rib 144 so as to open the door 140.

In addition, as shown in FIG. 6A, when the protrusion bar 183 is in the intercept position due to the rising and falling guide 166 being in the disc placing position and pivoting in the direction E along which the door 140 is to be opens, the protrusion bar 183 faces and gears with the protrusion piece 186 formed at the door 140 so as to intercept the movement of the protrusion piece 186. This limits the pivoting of the door 140. As a result, the door 140 is prevented from opening.

In FIG. 6B, the protrusion bar 183 is in the release position due to the rising and falling guide 166 which moves from the disc placing position toward the second movement direction F and pivots toward the direction E along which the door 140 opens. The protrusion bar 183 does not face and gear with the protrusion piece 186 to allow the movement of the protrusion piece 186 so that the door 140 freely pivots. As a result, the door 140 opens.

The door-safety apparatus 180 of the present invention further includes the stopper 198 limiting the movement of the protrusion bar 183 of the second protrusion 181, i.e., the movement of the rising and falling guide 166. The stopper 198 is formed on the front wall 150a of the main base 150 to gear with the guide groove 196 of the protrusion bar 183 so as to guide the guide groove 196. The stopper also includes the recess part 199 including first and second movement preventing curbs 199a and 199b. When the disc tray 120 is in the disc loading position as shown in FIG. 4A, and the disc unloading position as shown in FIG. 5A, the first and second movement preventing curbs 199a and 199b intercept the protrusion bar 183 from moving so as to intercept the rising and falling guide 166 from moving toward the second movement direction F or G.

The operation of the disc player 100 including the door-safety apparatus 180 of the present invention having the above-described structure will now be described in detail with reference to FIGS. 3 through 7.

The operation in which the disc tray 120 in the disc unloading position as shown in FIG. 5A loads a disc thereon and then is inserted in the disc loading position, will be described.

As a tray opening and closing button (not shown) is pressed, a controller rotates the loading motor 155 in one direction, for example, counterclockwise, to load the disc tray 120. In a case where the disc tray 120 is forcibly pushed into the disc loading position, the controller senses by using a sensor that the disc tray 120 has been moved, and then, rotates the loading motor 155 counterclockwise.

As the loading motor 155 rotates, the disc tray 120 moves in the first movement direction C due to the power of the loading motor 155 transmitted through the motor pulley 156, the belt 157, the gear pulley 158, the pinion gear 165 of the loading gear 159, and the first rack gear 123. The rising and falling guide 166 moves in the second movement direction G due to the power of the loading motor 155 transmitted through the second rack gear 167 gearing with the pinion gear 165. When a front end of the disc tray 120 passes through the opening 133 of the front panel 130 due to the movement of the disc tray 120, the door 140 pivots in the direction D along which the door 140 is to be closed due to a tension of the tension spring 191, and thus, is closed.

When the disc tray 120 is in the disc loading position, the pickup base 151, which has descended relatively down so as not to interfere with the movement of the disc tray 120, ascends.

In other words, as shown in FIG. 7, the guide bosses 154 and 154b of the pickup base 151 receive the power of the loading motor 155, and thus, are guided along the cam grooves 168 and 169 due to the movement of the rising and falling guide 166 in the second movement direction G. As a result, when the disc tray 120 is completely inserted into the front panel 130 through the opening 133, the pickup base 151 starts ascending.

The disc placed on the disc tray 120 is placed on the turntable 153 due to the ascent of the pickup base 151. When the turntable 153 goes further up due to the continuous ascent of the pickup base 151, the clap 163 claps the disc placed on the turntable 153.

Thereafter, when the disc tray 120 completely reaches the disc loading position as shown in FIG. 4A, the controller stops the loading motor 155, and the loading operation of the disc tray 120 is completed.

When the rising and falling guide 166 moves in the second movement direction G, and thus, is in the disc placing position, the protrusion bar 183 is preventing from moving by being intercepted by the second movement preventing curb 199b of the recess part 199 so as to stop the movement of the rising and falling guide 166. Also, as shown in FIG. 6A, the lower surface 183a of the front end of the protrusion bar 183 faces the upper surface 186a of the protrusion piece 186, and thus, is in the intercept position.

Therefore, although a child or a user pulls the door 140 in the direction E by a trick or through carelessness, the upper surface 186a of the protrusion piece 186 gears with the lower surface 183a of the front end of the protrusion bar 183. Thus, the door 140 does not pivot. As a result, the door 140 is not opened.

As described above, in the disc player 100 of the present invention, although a child or a user desires to open the door 140 by accident when the disc tray 120 is in the disc loading position, the door 140 is not opened. As a result, the child or the user can be protected from a safety-related accident occurring due to the high speed rotation of a disc caused by the opening of the door 140 during the operation of the disc player 100.

The operation of moving the disc tray 120 from the disc loading position to the disc unloading position as shown in FIG. 4A will now be described.

When the tray opening and closing button is pressed, the controller rotates the loading motor 155 in another direction, for example, clockwise, to remove the disc tray 120.

When the loading motor 155 rotates, the rising and falling guide 166 moves in the second movement direction F due to the power of the loading motor 155 that is transmitted through the motor pulley 156, the belt 157, the gear pulley 158, the pinion gear 165 of the loading gear 159, and the second rack gear 167.

As a result, the guide bosses 154a and 154b of the pickup base 151 are guided along the cam grooves 168 and 169 due to the rising and falling guide 166 that receives the power of the loading motor 155 in an ascent position, and thus, moves in the second movement direction F. Thus, as the guide bosses 154a and 154b are guided along the cam grooves 168 and 169, the pickup base 151 starts descending. The clap 163 is separated from the turntable 153 due to the descent of the pickup base 151 to release the disc. When the turntable 153 moves further down due to the continuous descent of the pickup base 151, the disc placed on the turntable 153 is placed on the disc tray 120.

The protrusion bar 183 formed at the second end 166b of the rising and falling guide 166 moves from the intercept position, in which the lower surface 183a of the front end of the protrusion bar 183 faces the upper surface 186a of the protrusion piece 186 formed at the door 140, towards the second movement direction F due to the movement of the rising and falling guide 166.

When the pickup base 151 completely descends so as not to interfere with the movement of the disc tray 120, the disc tray 120 moves towards the first movement direction B due to the power of the loading motor 155 that is transmitted through the motor pulley 156, the belt 157, the gear pulley 158, the pinion gear 165 of the loading gear 159, and the first rack gear 123.

When the front end of the disc tray 120 contacts the door 140 due to the movement of the disc tray 120, the protrusion bar 183 is the release position in which the lower surface 183a of the front end of the protrusion bar 183 does not face the upper surface 186a of the protrusion piece 186 formed at the door 140.

Thus, when the front end of the disc tray 120 further moves to push the door 140, the door 140 pivots towards the direction E. As a result, the door 140 is opened as shown in FIG. 6B.

As shown in FIGS. 5A and 5B, when the disc tray 120 completely reaches the disc unloading position, the protrusion bar 183 is prevented from moving by being intercepted by the first movement preventing curb 199a of the recess part 199 that stops the movement of the rising and falling guide 166, while the controller stops the loading motor 155.

As described above, in a door-safety apparatus and a disc player including the door-safety apparatus according to the present invention, when a disc tray is in a disc loading position, a door can be prevented from being forcibly opened. Thus, when a child or a user accidentally opens the door during the operation of the disc player, a safety-related accident that may occur due to a disc rotating at a high speed can be prevented.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A door-safety apparatus of a disc player comprising:
a front panel comprising an opening;
a door pivotally installed at the front panel to pivot between an opened position in which the opening is to be opened and a closed position in which the opening is to be closed;
a rising and falling guide ascending and descending a pickup base on which a turntable placing a disc thereon is installed; and
a door-forcibly-opening preventing unit installed between the door and the rising and falling guide and selectively limiting pivoting of the door according to a position of the rising and falling guide.

2. The door-safety apparatus of claim 1, wherein the door forcibly opening preventing unit comprises:
a first protrusion installed on an inner surface of the door; and
a second protrusion installed at the rising and falling guide and moving according to the position of the rising and falling between an intercept position in which the first protrusion is intercepted from moving with the door, and a release position in which the first protrusion is allowed to move.

3. The door-safety apparatus of claim 2, wherein the second protrusion is in the intercept position to limit the pivoting of the door when the rising and falling guide raises the pickup base to be in a disc placing position to place a disc on the turntable, and is in the release position to allow the pivoting of the door when the rising and falling guide gets out of the disc placing position.

4. The door-safety apparatus of claim 3, wherein:
the first protrusion comprises a protrusion piece protruding on the inner surface of the door inside the front panel and comprising at least one plane, and
the second protrusion comprises a protrusion bar extending toward the door and comprising a plane facing the plane of the protrusion piece when the second protrusion is in the intercept position.

5. The door-safety apparatus of claim 4, wherein the protrusion bar comprises a movement guide guiding a movement of the protrusion bar between the intercept position and the release position.

6. The door-safety apparatus of claim 5, wherein the movement guide comprises a guide groove formed in the vicinity of the plane of the protrusion bar so as to be guided along a wall of a main base on which the pickup base is installed.

7. The door-safety apparatus of claim 2, wherein the door forcibly opening preventing unit further comprises a stopper limiting a movement position of the rising and falling guide.

8. The door-safety apparatus of claim 7, wherein the stopper comprises a recess part formed at the wall of the main base on which the pickup base is installed so as to guide the second protrusion.

9. A disc player comprising:
a front panel assembly comprising a front panel comprising an opening, a door pivotably installed at the front panel to pivot between an opened position in which the opening is to be opened and a closed position in which the opening is to be closed, and an elastic member applying an elastic force to the door toward a direction along which the door pivots toward the closed position;
a body comprising a disc tray mounting a disc thereon and removed from or inserted into the front panel through the opening, and a rising and falling guide rising and falling a pickup base on which a turntable placing the disc thereon is installed; and
a door-safety apparatus comprising a door-forcibly-opening preventing unit installed between the door and the rising and falling guide and selectively limiting pivoting of the door according to a position of the rising and falling guide.

10. The disc player of claim 9, wherein the door forcibly opening preventing unit comprises:
a first protrusion installed on an inner surface of the door; and
a second protrusion installed at the rising and falling guide and moving according to the position of the rising and falling guide between an intercept position in which the first protrusion is intercepted from moving with the door, and a release position in which the first protrusion is allowed to move.

11. The disc player of claim 10, wherein the second protrusion is in the intercept position to limit the pivoting of the door when the rising and falling guide raises the pickup base to be in a disc placing position to place a disc on the turntable, and is in the release position to allow the pivoting of the door when the rising and falling guide gets out of the disc placing position.

12. The disc player of claim 11, wherein:
the first protrusion comprises a protrusion piece protruding on the inner surface of the door inside the front panel and comprising at least one plane, and
the second protrusion comprises a protrusion bar extending toward the door and comprising a plane facing the plane of the protrusion piece when the second protrusion is in the intercept position.

13. The disc player of claim 12, wherein the protrusion bar comprises a movement guide guiding a movement of the protrusion bar between the intercept position and the release position.

14. The disc player of claim 13, wherein the movement guide comprises a guide groove formed in the vicinity of the plane of the protrusion bar so as to be guided along a wall of a main base on which the pickup base is installed.

15. The disc player of claim 10, wherein the door forcibly opening preventing unit further comprises a stopper limiting a movement position of the rising and falling guide.

16. The disc player of claim 15, wherein the stopper comprises a recess part formed at the wall of the main base on which the pickup base is installed so as to guide the second protrusion.

17. A door-safety method of a disc player comprising:
including an opening in a front panel;
installing a door pivotally at the front panel;
ascending and descending a pickup base on which a turntable placing a disc thereon is installed; and
preventing the door from forcibly opening by selectively limiting pivoting of the door according to a position of a rising and falling guide.
